(19) United States
(12) Patent Application Publication
(10) Pub. No.: US 2025/0076657 A1
(43) Pub. Date: Mar. 6, 2025

(54) VIRTUAL IMAGE DISPLAY DEVICE AND OPTICAL UNIT

(71) Applicant: SEIKO EPSON CORPORATION, Tokyo (JP)

(72) Inventor: Jun IROBE, SUWA-SHI (JP)

(73) Assignee: SEIKO EPSON CORPORATION, Tokyo (JP)

(21) Appl. No.: 18/818,629

(22) Filed: Aug. 29, 2024

(30) Foreign Application Priority Data
Aug. 30, 2023 (JP) 2023-139665

(51) Int. Cl. G02B 27/01; F21V 8/00; G02B 27/00; G02B 27/30

(52) U.S. Cl. CPC G02B 27/0172; G02B 6/0016; G02B 6/002; G02B 6/0023; G02B 6/0068; G02B 6/0073; G02B 27/0081; G02B 2027/0114; G02B 2027/0116; G02B 2027/0178; G02B 27/30

(57) ABSTRACT

A virtual image display device includes a display panel that emits image light, a projection optical system that collimates the image light from the display panel, and a light guide member that includes a light guide plate that guides the image light, an input diffractive optical element that causes the image light to enter the light guide plate, and an output diffractive optical element that causes the image light to be emitted from the light guide plate, wherein the input diffractive optical element has a diffraction efficiency distribution having a tendency to cancel unevenness of the image light entering the input diffractive optical element.

The present application is based on, and claims priority from JP Application Serial Number 2023-139665, filed Aug. 30, 2023, the disclosure of which is hereby incorporated by reference herein in its entirety.

### BACKGROUND

### 1. Technical Field

The present disclosure relates to a virtual image display device and an optical unit that enable observation of a virtual image.

### 2. Related Art

A known diffractive display element incorporated in a virtual image display device includes a waveguide, an in-coupling region, an out-coupling region, and an emission pupil expander region, wherein the emission pupil expander region includes a large number of diffraction zones and a large number of non-diffraction zones arranged two-dimensionally (JP-T-2021-517265). In this diffractive display element, the uniformity of an image is improved over the entire angle of view in an eyebox through adjustment of the distribution of the two types of zones constituting the emission pupil expander region.

In a display device disclosed in JP-T-2021-517265, the uniformity in a beam at the time of emission onto the in-coupling region is not eliminated in the subsequent propagation, to be a factor resulting in compromised spatial uniformity at the time of arrival at the eyebox.

### SUMMARY

A virtual image display device and an optical unit according to an aspect of the present disclosure include a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element has a diffraction efficiency distribution having a tendency to cancel unevenness of the image light entering the input diffractive optical element.

### BRIEF DESCRIPTION OF THE DRAWINGS

FIG. 1 is a plan view used to explain a mounted state of an HMD as a first embodiment.

FIG. 2 is a side view used to explain an arrangement and the like of an optical system included in a virtual image display device.

FIG. 3 is a plan view used to explain the arrangement and the like of the optical system included in the virtual image display device.

FIG. 4 is a back view used to explain a light guide optical system or a light guide member.

FIG. 5 is a plan view used to explain an optical system of a first display driving unit.

FIG. 6 is an enlarged back view used to explain an input diffractive optical element.

FIG. 7 is a conceptual diagram illustrating a beam profile of light entering the input diffractive optical element.

FIG. 8 is a diagram used to explain a modification of the input diffractive optical element illustrated in FIG. 6.

FIG. 9 is a diagram used to specifically explain a diffractive structure formed on the input diffractive optical element.

FIG. 10 is a diagram used to explain a modification of the input diffractive optical element illustrated in FIG. 9.

FIG. 11 is a diagram used to explain optical characteristics of an optical system at an earlier stage than the light guide member.

FIG. 12 is a diagram used to explain a specific example of the input diffractive optical element.

FIG. 13 is a diagram used to explain an input diffractive optical element according to a second embodiment.

FIG. 14 is a diagram used to explain a modification of the input diffractive optical element illustrated in FIG. 13.

FIG. 15 is a diagram used to explain a specific example of the input diffractive optical element.

FIG. 16 is a diagram used to explain an input diffractive optical element according to a third embodiment.

FIG. 17 is a diagram used to explain a specific example of the input diffractive optical element.

FIG. 18 is a diagram used to explain a virtual image display device according to a fourth embodiment.

FIG. 19 is a diagram used to explain a modification of the input diffractive optical element.

FIG. 20 is a diagram used to explain another modification of the input diffractive optical element.

### DESCRIPTION OF EMBODIMENTS

### First Embodiment

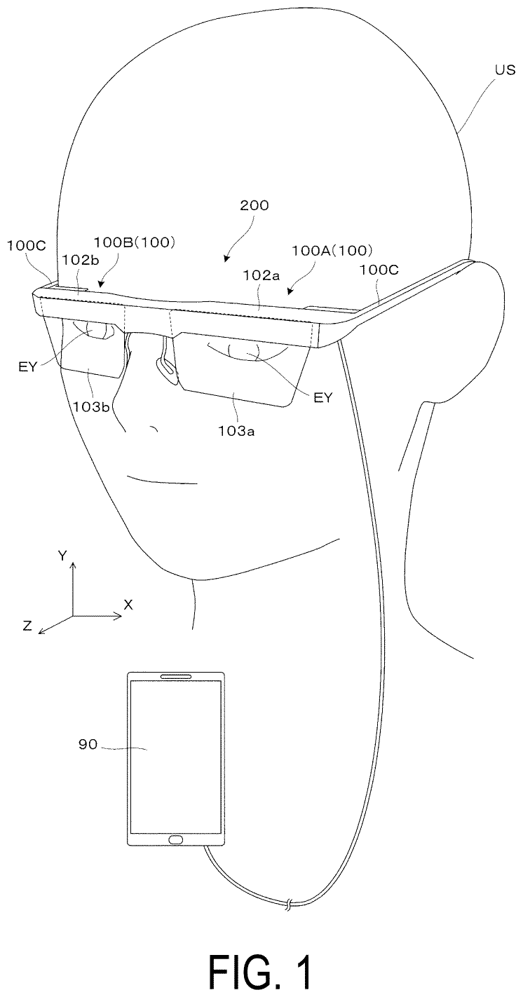

Below, a first embodiment of a virtual image display device according to the present disclosure will be described with reference to FIGS. 1 to 3 and the like.

FIG. 1 is a diagram used to explain a mounted state of a head-mounted display apparatus (hereinafter, also referred to as a head-mounted display or an “HMD”) 200, and the HMD 200 allows an observer or wearer US who is wearing the HMD 200 to recognize an image as a virtual image. In FIG. 1 and the like, X, Y, and Z represent a rectangular coordinate system. The +X direction corresponds to a lateral direction in which both eyes EY of the observer or the wearer US who wears the HMD 200 are arranged. The +Y direction corresponds to the upper direction perpendicular to the lateral direction from the viewpoint of the wearer US in which both eyes EY are arranged. The +Z direction corresponds to the forward direction or the front side direction from the viewpoint of the wearer US. The ±Y direction is parallel to the vertical axis or the vertical direction.

The HMD 200 includes a first virtual image display device 100A for the left eye, a second virtual image display device 100B for the right eye, a pair of temple-type support devices 100C that support the virtual image display devices 100A and 100B, and a user terminal 90 being an information terminal. The first virtual image display device 100A alone functions as the HMD, and includes a first display driving unit 102a disposed at an upper portion, and a first light guide optical system 103a having a shape of a spectacle lens and covering the front of the eye. Similarly, the second virtual image display device 100B alone functions as the HMD, and includes a second display driving unit 102b disposed at the upper portion, and a second light guide optical system 103b having a shape of a spectacle lens and covering the front of the eye. The support devices 100C are mounting members mounted on a head of the wearer US, and support upper end sides of the pair of light guide optical systems 103a and 103b via the display driving units 102a and 102b that are integrated in appearance. The first virtual image display device 100A and the second virtual image display device 100B are optically left-right inverted, and detailed description of the second virtual image display device 100B will be omitted.

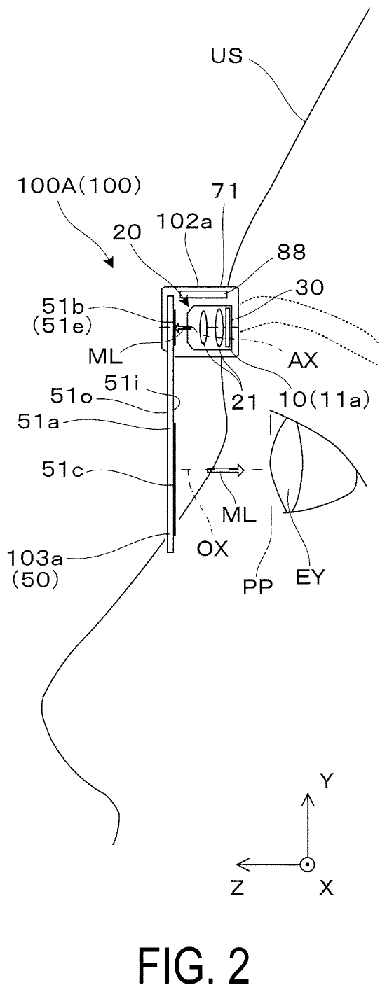

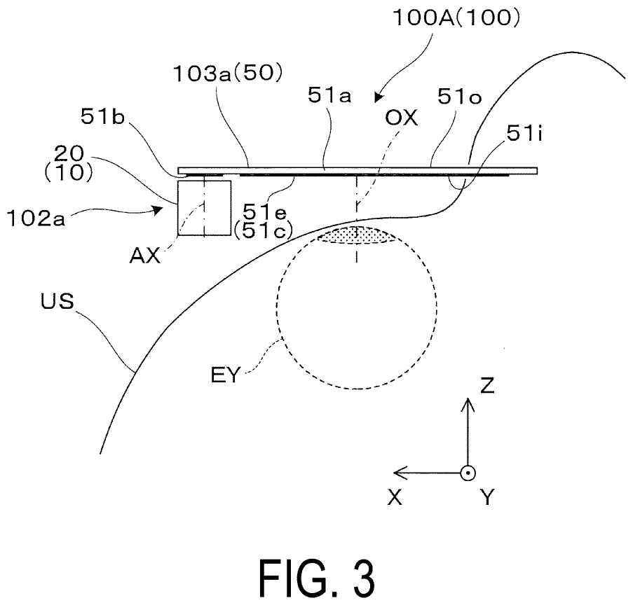

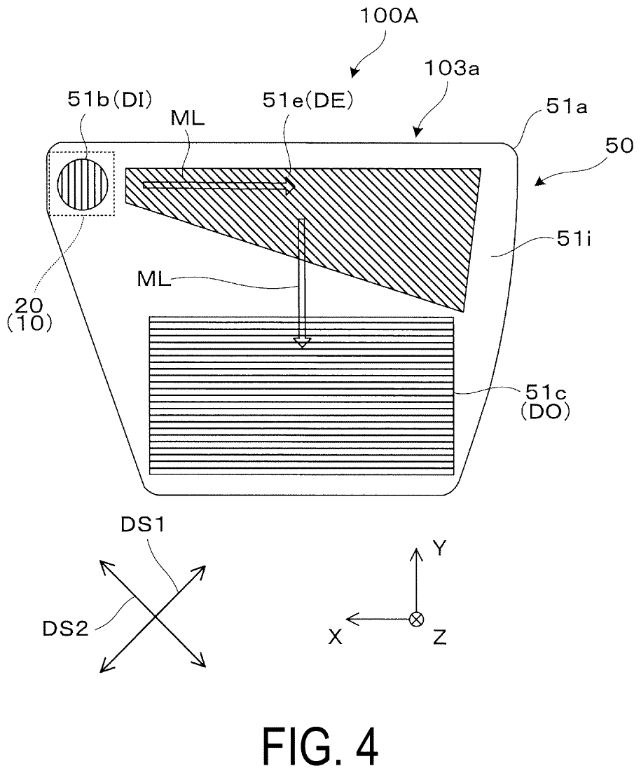

FIG. 2 is a side view used to specifically explain the first display driving unit 102a and the first light guide optical system 103a of the first virtual image display device 100A. FIG. 3 is a plan view used to specifically explain the first display driving unit 102a and the first light guide optical system 103a. FIG. 4 is a back view mainly used to explain the first light guide optical system 103a.

Referring to FIGS. 2 and 3, the first display driving unit 102a includes an image light generation device 10, a projecting optical system 20, and a drive circuit member 88. The image light generation device 10 is an optical engine including a display panel 11a. The projecting optical system 20 is a collimator including a plurality of lens elements 21. Image light ML generated by the image light generation device 10 is collimated by the projecting optical system 20, and is coupled to the first light guide optical system 103a serving as a light guide member 50. The drive circuit member 88 causes the display panel 11a to perform a display operation. Note that, in the first virtual image display device 100A, an optical device excluding the drive circuit member 88 is referred to as an optical unit 100. The first virtual image display device 100A guides the image light ML to the eyes EY of the wearer US, to make the wearer US visually recognize a virtual image.

Referring to FIG. 4, the first light guide optical system 103a is the light guide member 50 that enables color display, and extends substantially parallel to the XY plane. The first light guide optical system 103a includes a light guide plate 51a, an incident diffractive layer 51b, a pupil expanding grating layer 51e, and an emission diffractive layer 51c. The incident diffractive layer 51b, the emission diffractive layer 51c, and the pupil expanding grating layer 51e perform diffraction based on the wavelength of the image light ML. With the incident diffractive layer 51b, the collimated image light ML from the first display driving unit 102a is guided into and propagates in the lateral direction in the light guide plate 51a. With the pupil expanding grating layer 51e, the image light ML propagating in the lateral direction in the light guide plate 51a propagates in the lower direction while having the pupil size expanded. With the emission diffractive layer 51c, the image light ML propagating in the lower direction in the light guide plate 51a is emitted toward a pupil position PP (see FIG. 2) set to be on the inner side where the eyes EY (see FIG. 2) are present while having the pupil size of the image light ML expanded.

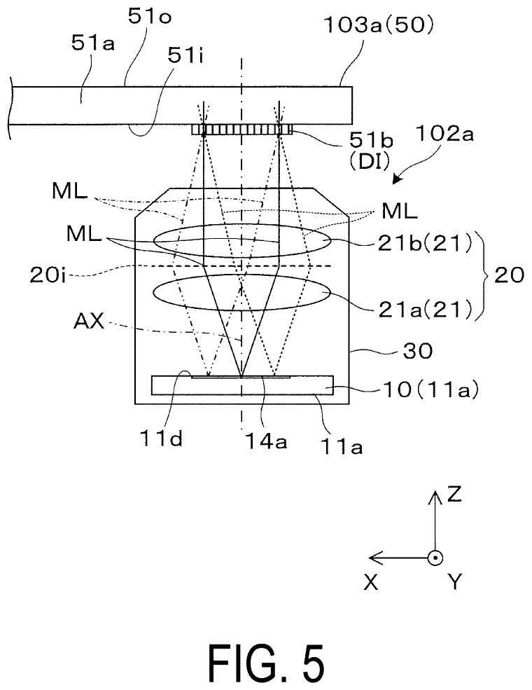

FIG. 5 is a diagram used to explain an optical system of the first display driving unit 102a. In the first display driving unit 102a, the image light generation device 10 includes only one display panel 11a. That is, the display panel 11a includes pixels of three colors RGB, and the pixels of the respective colors are two-dimensionally arranged in the display panel 11a. The projecting optical system 20 includes the plurality of lens elements 21. The display panel 11a and the projecting optical system 20 are fixed in a state of being positioned with respect to each other by a lens barrel 30. The lens barrel 30 is supported together with the drive circuit member 88 by a holder 71 (see FIG. 2) also serving as a cover while being positioned with respect to each other, and is fixed to the first light guide optical system 103a.

The display panel 11a is a display element or a display device that emits the image light ML to form an image corresponding to a virtual image. Specifically, the image display panel 11a is, for example, a display of various light emitting element arrays such as an organic light emitting diode (OLED), an organic electro-luminescence (EL), inorganic EL, or LED, and forms a still image or movie on a two-dimensional display surface parallel to the XY plane. The display panel 11a includes a light emitting element 14a. The light emitting element 14a includes a large number of pixel elements two-dimensionally arranged on a substrate along the XY plane. When the display panel 11a is an OLED display, the pixel elements of the light emitting element 14a each include a cathode, an electron transport layer, a light emitting layer, a hole transport layer, and a transparent electrode layer, arranged in this order from the substrate.

The display panel 11a is not limited to a self-luminous image light generation device and may be made of an LCD or other light modulation element and form an image by illuminating the light modulation element with a light source such as a back light. As the display panel 11a, a liquid crystal on silicon (trade name LCOS), a digital micromirror device, or the like can be used instead of an LCD.

The projecting optical system 20 includes a first lens 21a and a second lens 21b, as the lens elements 21 with which the incident light is collimated. The projecting optical system 20 has a function substantially equivalent to that of a single lens 20i, collimates the image light ML emitted from a display surface 11d of the display panel 11a to be in a state of having a predetermined beam width, and emits the resultant image light ML toward the incident diffractive layer 51b provided to the light guide member 50, in a state of an inclined angle corresponding to the pixel position. The projecting optical system 20 may include an optical element such as a reflection mirror, in addition to one or more lens elements made of resin or glass. The optical surface of the optical element or the lens elements 21 of the projecting optical system 20 may be any one of a spherical surface, an aspherical surface, and a free form surface.

Referring back to FIG. 4, in the first light guide optical system 103a or the light guide member 50, the incident diffractive layer 51b is an input diffractive optical element DI, and is formed with a diffraction pattern that extends linearly in the vertical Y direction and repeats periodically in the horizontal X direction. The emission diffractive layer 51c is an output diffractive optical element DO, and is formed with a diffraction pattern that extends linearly in the horizontal X direction and repeats periodically in the vertically Y direction. The pupil expanding grating layer 51e is a pupil expanding diffractive optical element DE, is provided on the −X side of the incident diffractive layer 51b, and bends the optical path to make the image light ML, which is guided in the light guide plate 51a and advancing as a whole in the −X direction, advance as a whole in the −Y direction.

The light guide plate 51a is a member formed of a parallel flat plate, and has a first total reflection surface 51i and a second total reflection surface 51o that form a pair of flat surfaces extending parallel to the XY plane (see FIG. 2).

The incident diffractive layer 51b, the emission diffractive layer 51c, and the pupil expanding grating layer 51e are formed on the first total reflection surface 51i of the light guide plate 51a.

The incident diffractive layer 51b, the emission diffractive layer 51c, and the pupil expanding grating layer 51e perform diffraction based on the wavelength of the image light ML, and are formed of a surface relief type diffraction element, for example. The surface relief type diffraction element is formed by nanoimprinting, but is not limited thereto, and may be formed by etching a surface of the light guide plate 51a, or may be formed by bonding a diffraction element.

The pupil expanding grating layer 51e changes the diffracting direction without substantially impairing angle information of the image light ML regarding the left and right X direction and angle information of the image light ML regarding the upper and lower Y direction. The pupil expanding grating layer 51e, that is, the pupil expanding diffractive optical element DE expands the pupil of the emission diffractive layer 51c while guiding the image light ML guided into the light guide plate 51a from the input diffractive optical element DI which is the incident diffractive layer 51b to the output diffractive optical element DO which is the emission diffractive layer 51c. More specifically, the pupil expanding grating layer 51e is interposed between the incident diffractive layer 51b and the emission diffractive layer 51c, guides the image light ML in a direction (−Y direction) intersecting with the diffracting direction (−X direction) of the incident diffractive layer 51b while dividing the light beam, and has a function of expanding the beam width in the lateral direction. The pupil expanding grating layer 51e is formed with a diffraction pattern that extends linearly in an oblique direction DS2 parallel to the XY plane and repeats periodically in a direction DS1 parallel to the XY plane and perpendicular to the direction DS2. The direction DS1 is a direction rotated clockwise by 45 degrees with respect to the +Y direction, and is an intermediate direction between the −X direction and the +Y direction. The grating period or the pitch in the X direction and the Y direction of the pattern formed on the pupil expanding grating layer 51e matches the grating period in the X direction of the pattern formed on the incident diffractive layer 51b and the grating period in the Y direction of the pattern formed on the emission diffractive layer 51c. The emission diffractive layer 51c divides the light beam while guiding the image light ML in the −Y direction, and has a function of expanding the light beam width in the vertical direction. As a result, the beam width, in the X direction and the Y direction, of the image light ML to enter the pupil position PP illustrated in FIG. 2 has a range corresponding to the emission diffractive layer 51c, and the pupil size in the vertical direction and the lateral direction increases through the pupil expanding grating layer 51e, the emission diffractive layer 51c, and the like. The image light ML collimated around the emission optical axis OX (see FIG. 2) perpendicular to the light guide plate 51a is emitted from the emission diffractive layer 51c. The image light ML emitted from the emission diffractive layer 51c has an angle of about ±25° with respect to the emission optical axis OX. Thus, the angle of view of the first virtual image display device 100A is about 50°.

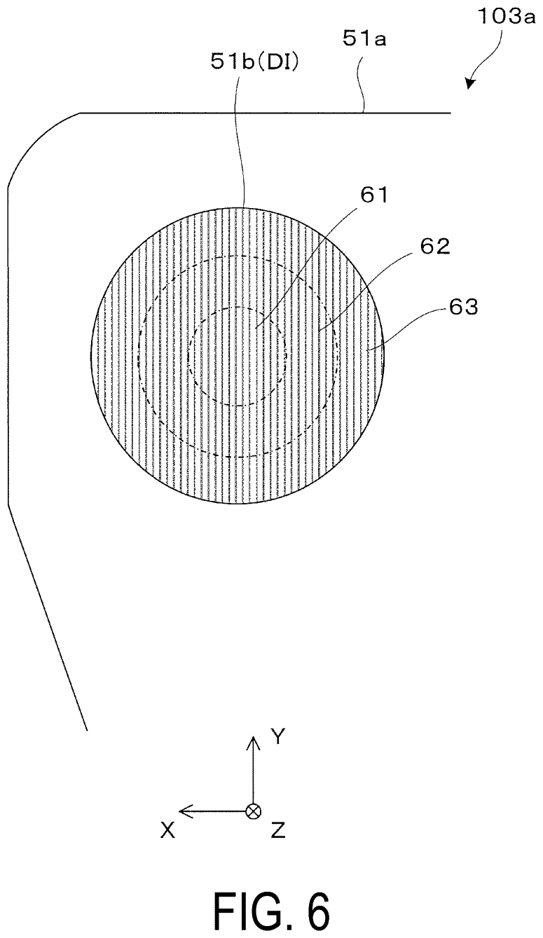

FIG. 6 is an enlarged view used to explain the incident diffractive layer 51b. The incident diffractive layer 51b has a concentric and symmetrical diffraction efficiency distribution. Specifically, regarding the diffractive characteristics, the illustrated incident diffractive layer 51b includes a first zone 61, a second zone 62, and a third zone 63 which are divided annular zones. The first zone 61 where the diffraction efficiency for the image light ML incident thereon is the lowest is located at the center. The third zone 63 where the diffraction efficiency for the image light ML incident thereon is the highest is the outermost zone.

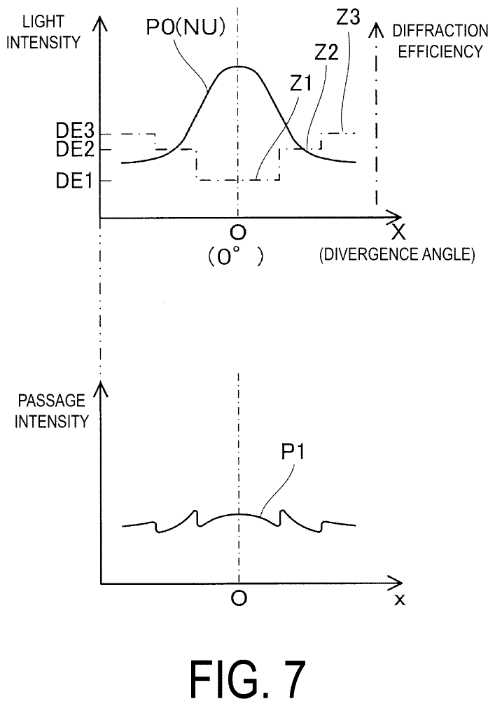

FIG. 7 is a conceptual diagram used to explain the beam profile of the image light ML entering the incident diffractive layer 51b. The upper chart illustrates a beam profile P0 of the image light ML entering the incident diffractive layer 51b, and the lower chart illustrates a beam profile P1 of the image light ML diffracted by the incident diffractive layer 51b and transmitted through the incident diffractive layer 51b. Here, the horizontal axis represents the position on the incident diffractive layer 51b in the X direction, and the vertical axis represents the light intensity. On the horizontal axis, a symbol O corresponds to a point which is the center of the incident diffractive layer 51b and through which an optical axis AX passes. As will be described later, in the beam profile P1, the spatial non-uniformity of the beam profile P0, that is, unevenness NU of the image light ML entering the incident diffractive layer 51b is almost cancelled, that is, the unevenness NU is substantially eliminated.

In this case, while the beams of the image light ML from the individual pixel elements of the light emitting element 14a of the display panel 11a enter the incident diffractive layer 51b in a superimposed manner, the relationship between the individual beam profiles of the image light ML entering the incident diffractive layer 51b from the individual pixel elements of the light emitting element 14a and the beam profile P0 of the image light ML in which the individual beam profiles are superimposed is relatively maintained, and their distributions are similar to each other. Although not specifically illustrated, the light distribution characteristic corresponding to the relationship between the divergence angle and the light intensity of the image light ML emitted from each pixel element of the light emitting element 14a indicates a pattern substantially similar to that of the beam profile PG.

In the upper chart, the dot-dash line indicates an example of the diffraction efficiency of the incident diffractive layer 51b. A region Z1 indicates the diffraction efficiency of the first zone 61, a region Z2 indicates the diffraction efficiency of the second zone 62, and a region Z3 indicates the diffraction efficiency of the third zone 63. Here, DE1<DE2<DE3 holds where DE1, DE2, and DE3 are respectively the diffraction efficiencies of the first zone 61, the second zone 62, and the third zone 63. As a result, as illustrated in the lower chart, the beam profile P1 of the image light ML that has been diffracted while passing through the incident diffractive layer 51b is in a state with almost no relative difference in light intensity among the zones 61, 62, and 63.

The beam profile P1 of the image light ML diffracted while passing through the incident diffractive layer 51b may be higher in the center zone 61 than in the peripheral zone 63 by a predetermined degree, or conversely may be higher in the peripheral zone 63 than in the center zone 61 by a predetermined degree. Furthermore, the beam profile P1 of the image light ML that has passed through the incident diffractive layer 51b may be higher in the intermediate zone 62 than in the zones 61 and 63 on both sides by a predetermined degree, or conversely may be lower in the intermediate zone 62 than in the zones 61 and 63 on both sides by a predetermined degree. Specifically, for example, if a difference between the illuminance after passage through the center zone 61 and the illuminance after passage through the peripheral zone 63 is about ±40% or less based on the higher one of the illuminances, the input diffractive optical element DI can be regarded as having a diffraction efficiency distribution exhibiting a tendency to cancel the unevenness NU of the image light ML entering the input diffractive optical element DI. Note that the difference between the illuminance after passage through the center zone 61 and the illuminance after passage through the peripheral zone 63 is about ±25% or less based on the higher one of the illuminances.

In the above description, the incident diffractive layer 51b includes the three zones 61, 62, and 63 having different diffraction efficiencies. Increase in the number of zones leads to the beam profile P1 of the image light ML diffracted while passing through the incident diffractive layer 51b having a flatter characteristic than that illustrated in the figure. If the diffraction efficiency of the incident diffractive layer 51b continuously changes in accordance with the distance from the optical axis AX, the beam profile P1 of the image light ML can be made uniform and flat. More specifically, an emission angle θ of the image light ML and a position x of the image light ML entering the incident diffractive layer 51b are set to satisfy an expression x=f(θ) of relationship between the emission angle θ and the position x determined by the characteristics of the projecting optical system 20. In this case, in consideration of the light distribution characteristics of the image light ML emitted from the light emitting element 14a, when the function of the light intensity distribution or illuminance distribution immediately before incidence on the incident diffractive layer 51b is defined as g(x)=g(f(θ)), diffraction efficiency E(x) and diffraction efficiency E(θ) to be set for the incident diffractive layer 51b have a distribution that cancels the light intensity distribution. Specifically, diffraction efficiency E(x), E(θ)∝1/g(x)=1/g(f(θ)) holds. While the original beam profile P0 of the image light ML is, for example, a Lambertian light distribution (light intensity∝COS θ), by setting the diffraction efficiency E(x) or the diffraction efficiency E(θ) as described above, the non-uniformity of the beam profile P0 which causes the unevenness in the beam after being coupled to the light guide plate 51a is eliminated.

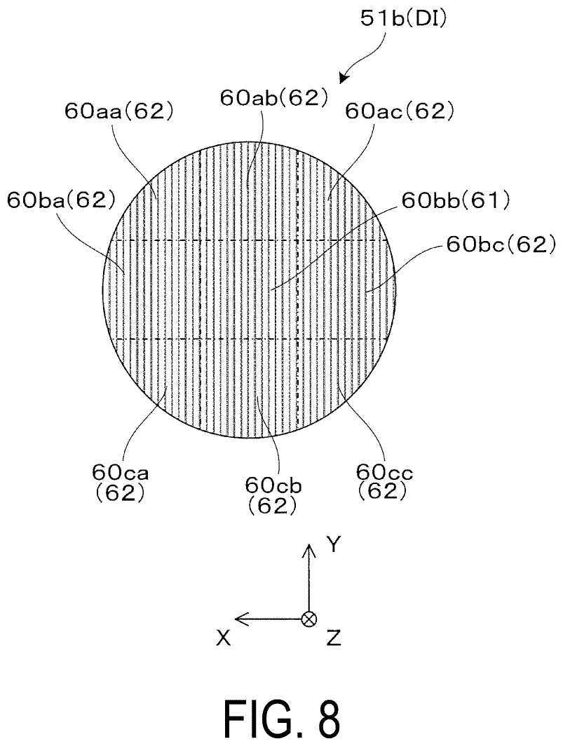

FIG. 8 is a diagram used to explain a modification of the incident diffractive layer 51b illustrated in FIG. 6. In this case, 3×3 block areas 60aa, 60ab, 60ac, 60ba, 60bb, 60bc, 60ca, 60cb, and 60cc arranged in a matrix are included. Here, the block area 60bb can be regarded as corresponding to the first zone 61 at the center, and the remaining block areas 60aa, 60ab, 60ac, 60ba, 60bc, 60ca, 60cb, and 60cc can be regarded as corresponding to the second zone 62 in the periphery. In this case, DE1<DE2 holds where DE1 is the diffraction efficiency of the first zone 61 including the block area 60bb and DE2 is the diffraction efficiency of the second zone 62 including the block area 60aa and the like. Thus, the image light ML is less attenuated in the second zone 62 in the periphery than in the first zone 61 at the center, and the difference in the beam profile of the image light ML diffracted while passing through the incident diffractive layer 51b between the center and the periphery is made small, whereby uniformity is achieved.

While the incident diffractive layer 51b includes 3×3 block areas in the above description, the incident diffractive layer 51b may include n×n (n is a natural number) block areas. When n is increased, it becomes easy to flatten the beam profile of the image light ML diffracted while passing through the incident diffractive layer 51b. The block area needs not be square but may be rectangular. Still, it is desirable that each of the zones sectionalized by the block areas is formed to be in a rotationally symmetric annular shape.

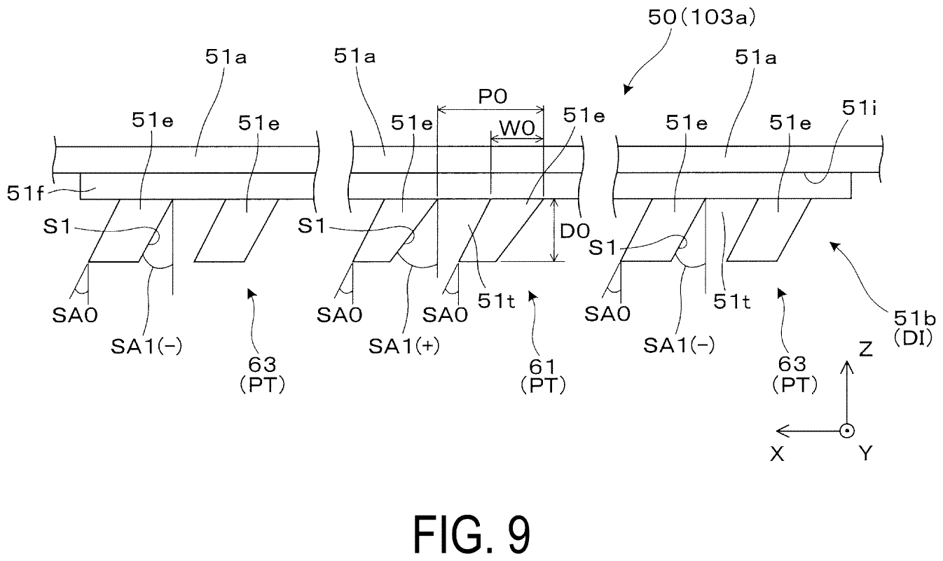

FIG. 9 is a diagram used to specifically explain the diffractive structure formed in the incident diffractive layer 51b which is the input diffractive optical element DI. The incident diffractive layer 51b is a slanted type diffractive optical element and is formed with a pattern PT having periodicity in the lateral X direction. The pattern PT includes a large number of protruding portions 51e protruding from a foundation layer 51f in the −Z direction and extending in the vertical Y direction and grooves 51t. The grating period of this pattern PT is set to make the angle of reflection or the angle of incidence in the light guide plate 51a greater than a critical angle determined by the refractive index of the light guide plate 51a such that the image light ML propagates in the light guide plate 51a by total reflection.

The cross-sectional shape of the protruding portion 51e in the first zone 61 at the center is different from the cross-sectional shape of the protruding portion 51e in the third zone 63 in the periphery. The cross-sectional shape of the protruding portion 51e is obtained by changing the inclination of a side surface S1 on the −X side according to the position, based on a parallelogram cross section along an XZ plane having, as a basic inclination, the inclination angle SA0 rotated clockwise with the −Z direction serving as a reference. In the protruding portion 51e formed in the first zone 61 at the center, when the inclination angle of the side surface S1 is defined as SA1(+), and in the protruding portion 51e formed in the third zone 63 in the periphery, the inclination angle of the side surface S1 is defined as SA1(−), the inclination angle SA1(+) in the first zone 61 is set to be larger than the inclination angle SA1(−) in the third zone 63. Note that, all the protruding portions 51e have no difference in depth D and duty ratio W0/P0 of the pattern PT. With the inclination angle SA1(+) of the side surface S1 thus being relatively large in the first zone 61, the diffraction efficiency in the first zone 61 at the center can be made lower than that in the third zone 63 in the periphery. While the diffraction efficiency distribution of the incident diffractive layer 51b is adjusted in two stages in the above description, the diffraction efficiency distribution can be adjusted in three or more stages by the annular zones.

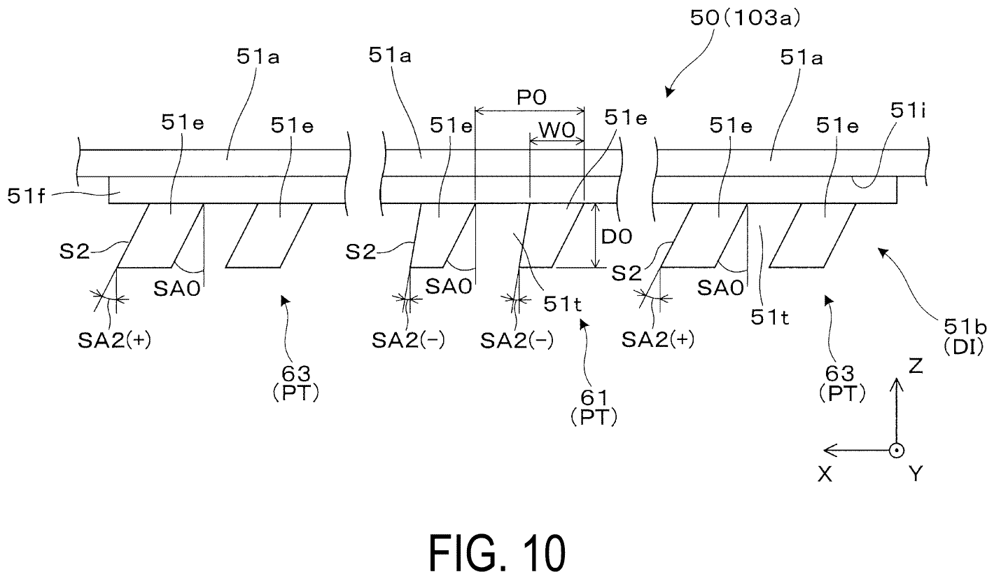

FIG. 10 is a diagram used to explain the diffractive structure of a modification of the incident diffractive layer 51b illustrated in FIG. 9. According to the incident diffractive layer 51b illustrated, the cross-sectional shape of the protruding portion 51e is obtained by changing the inclination of a side surface S2 on the +X side according to the position, based on a parallelogram cross section along an XZ plane having, as a basic inclination, the inclination angle SA0 rotated clockwise with the −Z direction serving as a reference. In the protruding portion 51e formed in the first zone 61 at the center, when the inclination angle of the side surface S2 is defined as SA2(−), and in the protruding portion 51e formed in the third zone 63 in the periphery, the inclination angle of the side surface S2 is defined as SA2(+), the inclination angle SA2(−) in the first zone 61 is set to be larger than the inclination angle SA2(+) in the third zone 63. Note that, all the protruding portions 51e have no difference in depth D and duty ratio W0/P0 of the pattern PT. With the inclination angle SA2(−) of the side surface S2 thus being relatively small in the first zone 61, the diffraction efficiency in the first zone 61 at the center can be made lower than that in the third zone 63 in the periphery. While the diffraction efficiency distribution of the incident diffractive layer 51b is adjusted in two stages in the above description, the diffraction efficiency distribution can be adjusted in three or more stages by the annular zones.

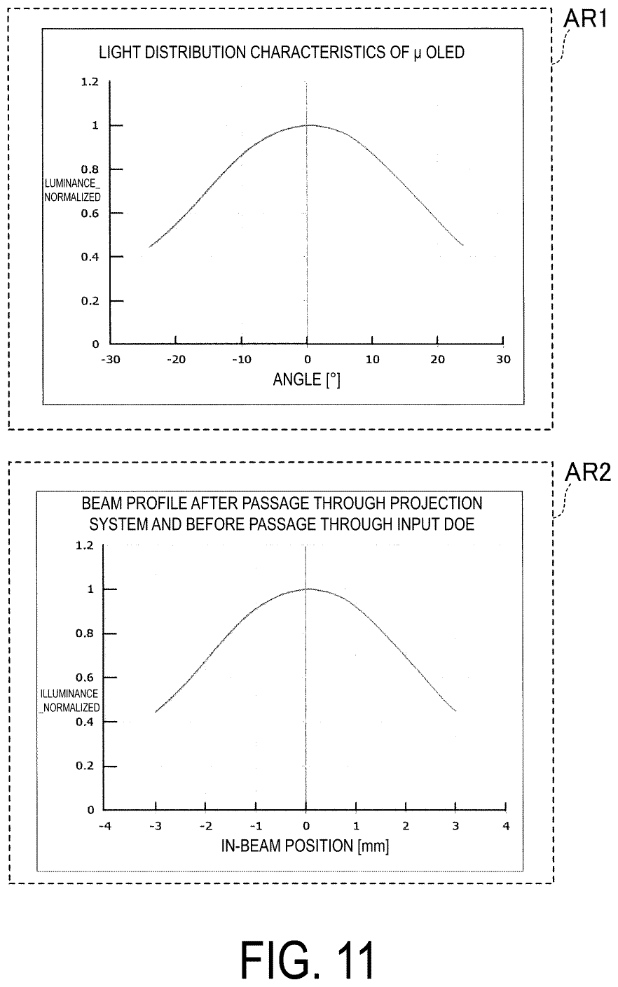

FIG. 11 is a diagram used to explain optical characteristics of an optical system at an earlier stage than the light guide member 50. In FIG. 11, a region AR1 indicates a specific example of the orientation characteristic of the display panel 11a, and a region AR2 indicates the beam profile of the image light ML having passed through the projecting optical system 20. In the orientation characteristic, the horizontal axis represents the emission angle of the image light ML, and the vertical axis represents the normalized luminance or illuminance. In the beam profile, the horizontal axis indicates a position after passage through the center of the incident diffractive layer 51b, parallel to the X direction. The display panel 11a is in particular a micro-display of organic light emitting diodes. According to the micro OLED display, light up to ±240 out of the image light ML emitted from the micro OLED display is captured by the projecting optical system 20 and collimated with the emission pupil diameter of 3 mm. The orientation characteristic and the beam profile of the image light ML are close to a Gaussian distribution. Even if the display panel 11a is a micro LED display, the orientation characteristic of the image light ML has high directivity as described above, and the beam profile has a tendency to achieve high luminance at the center on the front side.

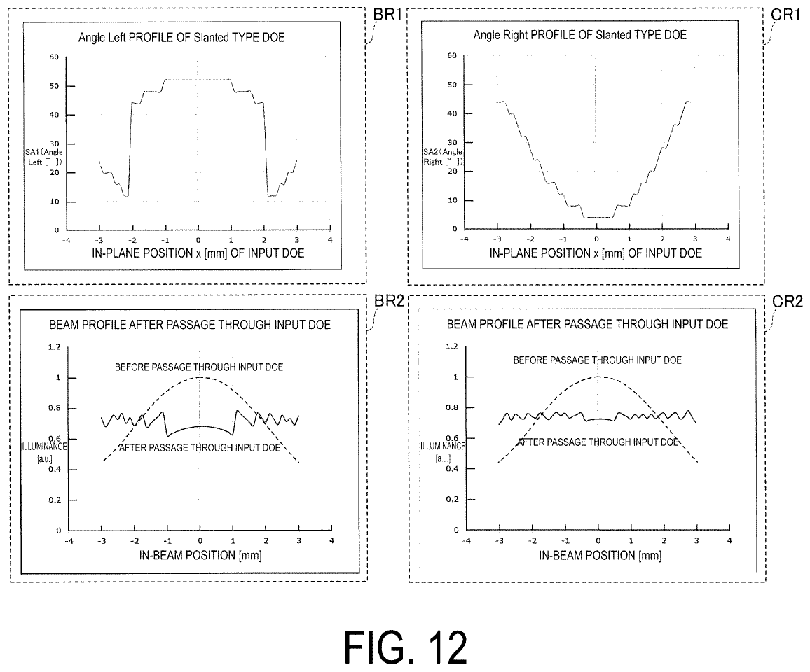

FIG. 12 is a diagram used to explain a specific example of the incident diffractive layer 51b. In FIG. 12, a region BR1 is a chart used to explain the pattern PT of the incident diffractive layer 51b illustrated in FIG. 9, and a region BR2 indicates the beam profile of the image light ML immediately after passing through the incident diffractive layer 51b illustrated in FIG. 9. In FIG. 12, a region CR1 is a chart used to explain the pattern PT of the incident diffractive layer 51b illustrated in FIG. 10, and a region CR2 indicates the beam profile of the image light ML immediately after passing through the incident diffractive layer 51b illustrated in FIG. 10. In the above description, the refractive index of the glass material forming the light guide plate 51a is 1.9, and the refractive index of the material forming the incident diffractive layer 51b is 2.0. The pattern PT has a depth DO of 300 nm, a pitch P0 of 380 nm, and a lateral length W0 of 190 nm. Further, the inclination angle SA0 is 40°. The depth DO, the lateral length W0, the pitch P0, the inclination angles SA0, SA1, and SA2, and the like are design parameters.

In the example illustrated in the region BR1 in FIG. 12 (corresponding to FIG. 9), the inclination angle SA1 of the side surface S1 of the protruding portion 51e forming the pattern PT changes discontinuously and nonlinearly in accordance with the position of the incident diffractive layer 51b in the X direction. The inclination angle SA1 of the side surface S1 tends to be largest at the position of x=0 through which the optical axis AX passes and smallest in the periphery (about x=±3 mm). The inclination angle SA1 is also expressed as Angle Left on the assumption that it is viewed from the +Z side. As illustrated in the region BR2 of FIG. 12, the beam profile after the passage through the slanted type incident diffractive layer 51b is adjusted to be substantially uniform regardless of the position in the X direction. That is, the design parameters of the incident diffractive layer 51b are set so as to uniformize the beam profile of the image light entering the incident diffractive layer 51b from the projecting optical system 20. The beam profile before the passage through the incident diffractive layer 51b is indicated by a dotted line. It can be seen that the beam profile after the passage through the slanted type incident diffractive layer 51b is spatially uniformized compared with the original.

In the example illustrated in the region CR1 in FIG. 12 (corresponding to FIG. 10), the inclination angle SA2 of the side surface S2 of the protruding portion 51e forming the pattern PT changes discontinuously and nonlinearly in accordance with the position of the incident diffractive layer 51b in the X direction. The inclination angle SA2 of the side surface S2 tends to be smallest at the position of x=0 through which the optical axis AX passes and largest in the periphery (about x=±3 mm). The inclination angle SA2 is also expressed as Angle Right on the assumption that it is viewed from the +Z side. As illustrated in the region CR2 of FIG. 12, the beam profile after the passage through the slanted type incident diffractive layer 51b is adjusted to be substantially uniform regardless of the position in the X direction.

The virtual image display device 100A, 100B of the first embodiment described above includes the display panel 11a configured to emit the image light ML, the projecting optical system 20 configured to collimate the image light ML from the display panel 11a, and the light guide member 50 that includes the light guide plate 51a configured to guide the image light ML, the input diffractive optical element DI configured to cause the image light ML to enter the light guide plate 51a, and the output diffractive optical element DO configured to cause the image light ML to be emitted from the light guide plate 51a, wherein the input diffractive optical element DI has a diffraction efficiency distribution having a tendency to cancel the unevenness NU of the image light ML entering the input diffractive optical element DI.

In the virtual image display device 100A, 100B, since the input diffractive optical element DI has the diffraction efficiency distribution having a tendency to cancel the unevenness NU of the image light ML incident thereon, even if the unevenness NU of the image light ML is formed on the input diffractive optical element DI due to the light distribution characteristics of the display panel 11a, the image light ML can be guided into the light guide plate 51a with the distribution thereof regulated. Thus, the display unevenness such as pixel luminance variation due to a movement of the line of sight.

### Second Embodiment

A virtual image display device according to a second embodiment of the present disclosure is described below. Note that the virtual image display device of the second embodiment is a partial modification of the virtual image display device of the first embodiment, and description of common parts is omitted.

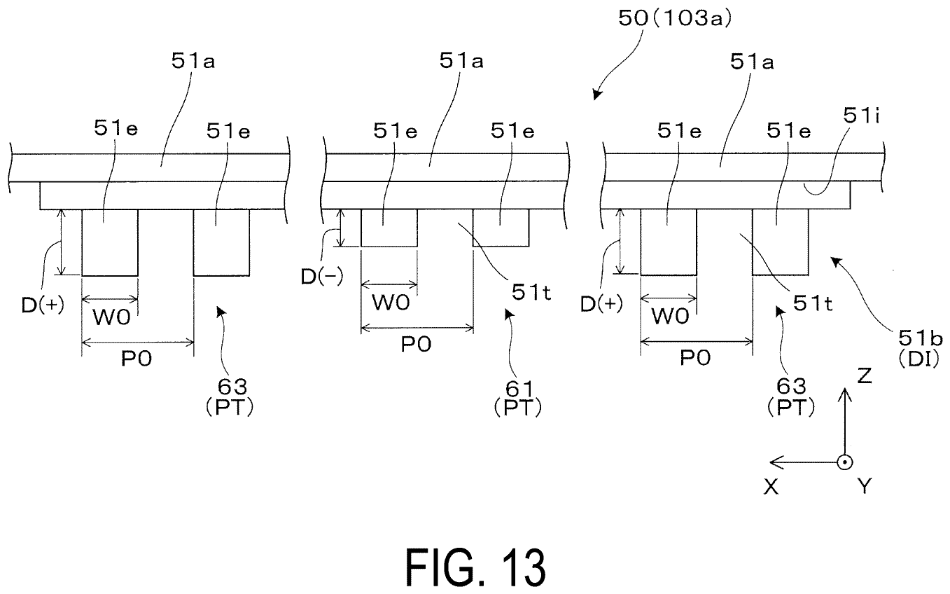

FIG. 13 is a diagram used to specifically explain a diffractive structure formed on the incident diffractive layer 51b of the light guide member 50 in a virtual image display device according to the second embodiment. The incident diffractive layer 51b which is the input diffractive optical element DI is a binary type diffractive optical element is formed with the pattern PT including a large number of protruding portions 51e and grooves 51t extending in the vertical Y direction, and having periodicity in the horizontal X direction.

The cross-sectional shape of the protruding portion 51e in the first zone 61 at the center is different from the cross-sectional shape of the protruding portion 51e in the third zone 63 in the periphery. The cross-sectional shape of the protruding portion 51e is obtained by changing the depth, which is the vertical size, according to the position. When the depth of the protruding portion 51e formed in the first zone 61 at the center is defined as D(−) and the depth of the protruding portion 51e formed in the third zone 63 in the periphery is defined as D(+), the depth D(−) of the first zone 61 is set to be smaller than the depth D(+) of the third zone 63. Note that, all the protruding portions 51e have no inclination and have no difference in duty ratio W0/P0 of the pattern PT. With the depth D(−) of the protruding portion 51e thus being relatively small in the first zone 61, the diffraction efficiency in the first zone 61 at the center can be made lower than that in the third zone 63 in the periphery. While the diffraction efficiency distribution of the incident diffractive layer 51b is adjusted in two stages in the above description, the diffraction efficiency distribution can be adjusted in three or more stages by the annular zones.

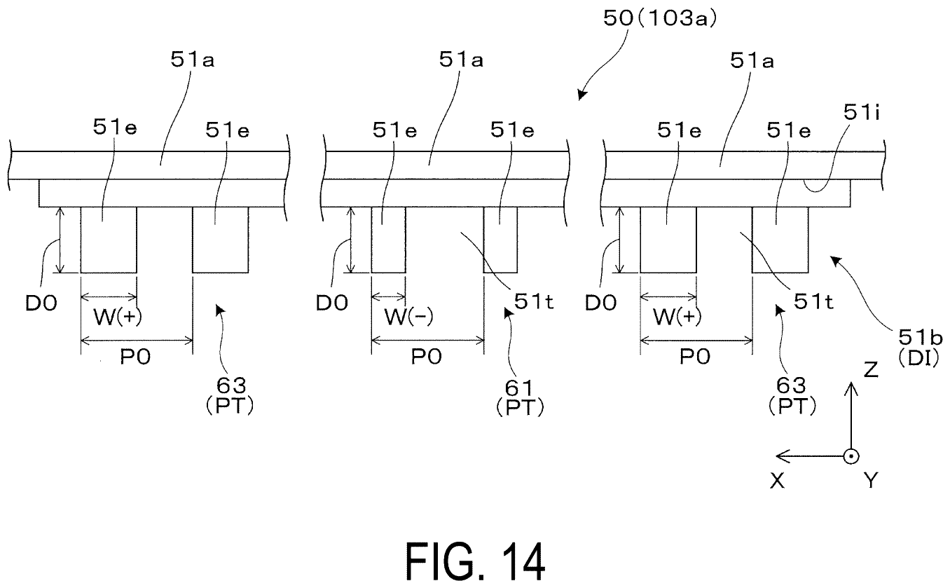

FIG. 14 is a diagram used to explain the diffractive structure of a modification of the incident diffractive layer 51b illustrated in FIG. 13. In the case of the incident diffractive layer 51b illustrated in the figure, the cross-sectional shape of the protruding portion 51e is obtained by changing the duty ratio which is an occupancy ratio with respect to the whole, that is, the ratio of the lateral length W0 to the pitch P0 according to the position. When the duty ratio of the protruding portion 51e formed in the first zone 61 at the center is defined as W(−)/P0 and the duty ratio of the protruding portion 51e formed in the third zone 63 in the periphery is defined as W(+)/P0, the duty ratio W(−)/P0 in the first zone 61 is set to be lower than the duty ratio W(+)/P0 in the third zone 63. Note that, all the protruding portions 51e have no inclination and have no difference in depth D of the pattern PT. With the duty ratio W(−)/P0 of the protruding portion 51e thus being relatively small in the first zone 61, the diffraction efficiency in the first zone 61 at the center can be made lower than that in the third zone 63 in the periphery. While the diffraction efficiency distribution of the incident diffractive layer 51b is adjusted in two stages in the above description, the diffraction efficiency distribution can be adjusted in three or more stages by the annular zones.

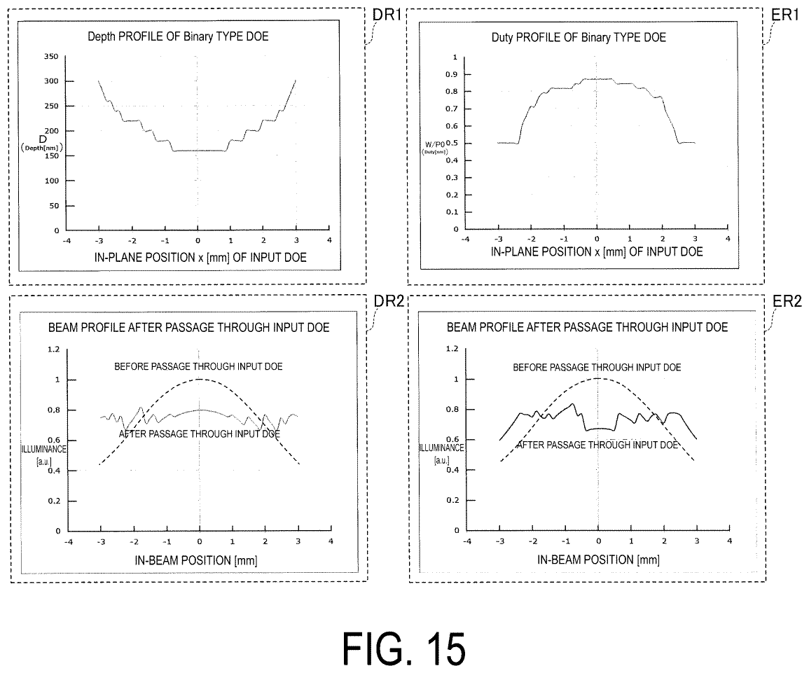

FIG. 15 is a diagram used to explain a specific example of the incident diffractive layer 51b. In FIG. 15, a region DR1 is a chart used to explain the pattern PT of the incident diffractive layer 51b illustrated in FIG. 13, and a region DR2 indicates the beam profile of the image light ML immediately after passing through the incident diffractive layer 51b illustrated in FIG. 13. In FIG. 15, a region ER1 is a chart used to explain the pattern PT of the incident diffractive layer 51b illustrated in FIG. 14, and a region ER2 indicates the beam profile of the image light ML immediately after passing through the incident diffractive layer 51b illustrated in FIG. 14. In the above description, the refractive index of the glass material forming the light guide plate 51a is 1.9, and the refractive index of the material forming the incident diffractive layer 51b is 2.0. The pattern PT has a depth DO of 300 nm, a pitch P0 of 380 nm, and a lateral length W0 of 190 nm. The depths D0 and D, the lateral lengths W0 and W, the pitch P0, and the like are design parameters.

In the example illustrated in the region DR1 in FIG. 15 (corresponding to FIG. 13), the groove depth D of the protruding portion 51e forming the pattern PT changes discontinuously and nonlinearly in accordance with the position of the incident diffractive layer 51b in the X direction. The groove depth D tends to be smallest at the position of x=0 through which the optical axis AX passes and largest in the periphery (about x=±3 mm). As illustrated in the region DR2 of FIG. 15, the beam profile after the passage through the binary type incident diffractive layer 51b is adjusted to be substantially uniform regardless of the position in the X direction. It can be seen that the beam profile after the passage through the binary type incident diffractive layer 51b is spatially uniformized compared with the original.

In the example illustrated in the region ER1 in FIG. 15 (corresponding to FIG. 14), the duty ratio W/P0 of the protruding portion 51e forming the pattern PT changes discontinuously and nonlinearly in accordance with the position of the incident diffractive layer 51b in the X direction. The duty ratio W/P0 tends to be lowest at the position of x=0 through which the optical axis AX passes and highest in the periphery (about x=±3 mm). As illustrated in the region ER2 of FIG. 15, the beam profile after the passage through the binary type incident diffractive layer 51b is adjusted to be substantially uniform regardless of the position in the X direction. That is, the design parameters of the incident diffractive layer 51b are set so as to uniformize the beam profile of the image light entering the incident diffractive layer 51b from the projecting optical system 20.

### Third Embodiment

A virtual image display device according to a third embodiment of the present disclosure is described below. Note that the virtual image display device of the third embodiment is a partial modification of the virtual image display device of the first embodiment, and description of common parts is omitted.

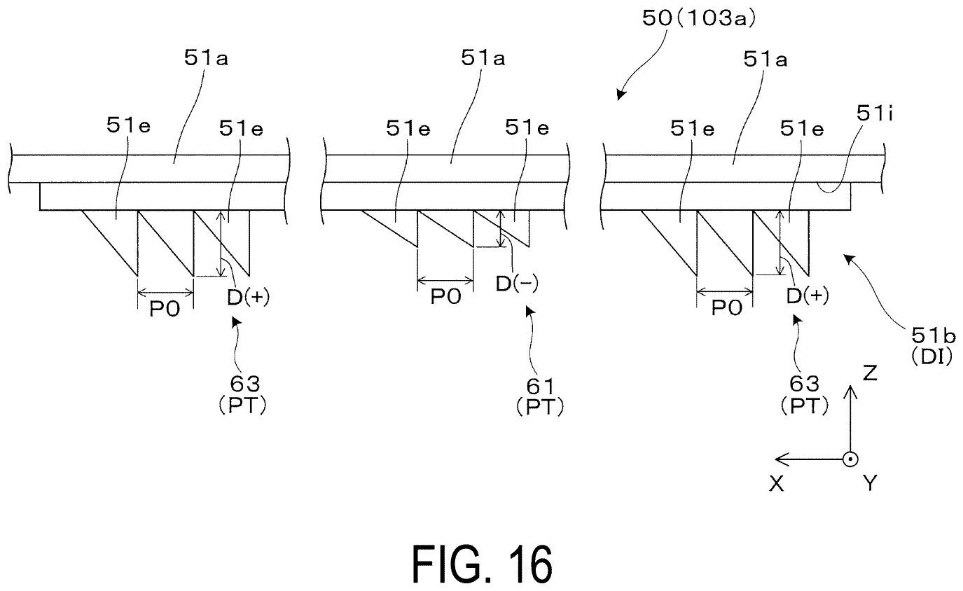

FIG. 16 is a diagram used to specifically explain a diffractive structure formed on the incident diffractive layer 51b of the light guide member 50 in a virtual image display device according to the third embodiment. The incident diffractive layer 51b which is the input diffractive optical element DI is a blazed type diffractive optical element formed with the pattern PT including a large number of protruding portions 51e extending in the vertical Y direction, and having periodicity in the horizontal X direction.

The triangular cross-sectional shape of the protruding portion 51e in the first zone 61 at the center is different from the triangular cross-sectional shape of the protruding portion 51e in the third zone 63 in the periphery. The cross-sectional shape of the protruding portion 51e is obtained by changing the depth, which is the vertical size, according to the position. When the depth of the protruding portion 51e formed in the first zone 61 at the center is defined as D(−) and the depth of the protruding portion 51e formed in the third zone 63 in the periphery is defined as D(+), the depth D(−) of the first zone 61 is set to be smaller than the depth D(+) of the third zone 63. Note that, all the protruding portions 51e have no difference in the lateral length or the pitch P0 of the pattern PT. With the depth D(−) of the protruding portion 51e thus being relatively small in the first zone 61, the diffraction efficiency in the first zone 61 at the center can be made lower than that in the third zone 63 in the periphery. While the diffraction efficiency distribution of the incident diffractive layer 51b is adjusted in two stages in the above description, the diffraction efficiency distribution can be adjusted in three or more stages by the annular zones.

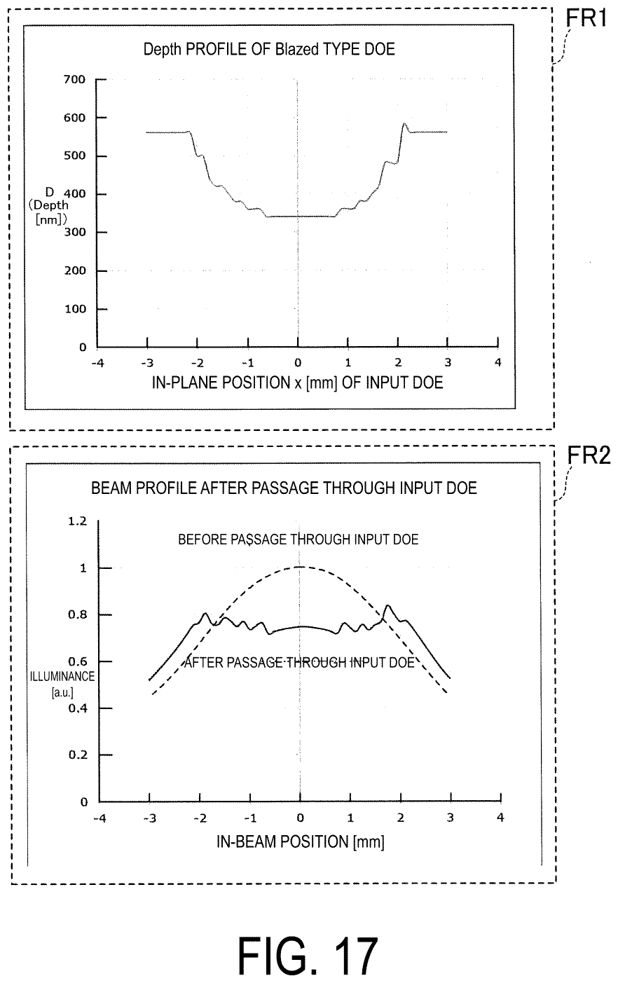

FIG. 17 is a diagram used to explain a specific example of the incident diffractive layer 51b. In FIG. 17, a region FR1 is a chart used to explain the pattern PT of the incident diffractive layer 51b illustrated in FIG. 16, and a region FR2 indicates the beam profile of the image light ML immediately after passing through the incident diffractive layer 51b illustrated in FIG. 16. In the above description, the refractive index of the glass material forming the light guide plate 51a is 1.9, and the refractive index of the material forming the incident diffractive layer 51b is 2.0. The pitch P0 of the pattern PT is 380 nm.

In the example illustrated in the region FR1 in FIG. 17, the depth D of the protruding portion 51e forming the pattern PT changes discontinuously and nonlinearly in accordance with the position of the incident diffractive layer 51b in the X direction. The depth D tends to be smallest at the position of x=0 through which the optical axis AX passes and largest in the periphery (about x=±3 mm). As illustrated in the region FR2 of FIG. 17, the beam profile after the passage through the blazed type incident diffractive layer 51b is adjusted to be substantially uniform regardless of the position in the X direction. It can be seen that the beam profile after the passage through the blazed type incident diffractive layer 51b is spatially uniformized compared with the original.

### Fourth Embodiment

A virtual image display device according to a fourth embodiment of the present disclosure is described below. Note that the virtual image display device of the fourth embodiment is a partial modification of the virtual image display device of the first embodiment, and description of common parts will be omitted.

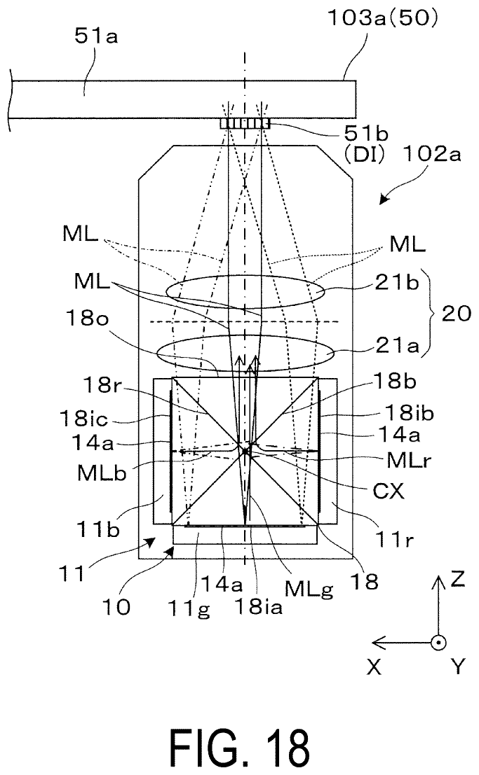

FIG. 18 is a diagram used to explain an optical system of the first display driving unit 102a. In the first display driving unit 102a, the image light generation device 10 includes three display panels 11r, 11b, and 11g and a cross dichroic prism 18. The projecting optical system 20 is a collimator including a plurality of lenses 21a and 21b.

The display panel 11r for red is a first display panel and emits red image light MLr which is first image light. The display panel 11r is, for example, an organic light emitting diode display, forms a still image or a movie on a two-dimensional display surface parallel to the YZ plane, and emits the red image light MLr.

The display panel 11b for blue is a second display panel and emits blue image light MLb which is second image light. Like the display panel 11r for red, the display panel 11b is, for example, an organic light emitting diode display, forms a still image or a movie on a two-dimensional display surface parallel to the YZ plane, and emits the blue image light MLb. The light emitting element 14a incorporated in the display panel 11b for blue and the light emitting element 14a of the display panel 11r for red are different from each other in light emitting wavelength. Thus, the blue image light MLb which is the second image light and the red image light MLr which is the first image light are different from each other in wavelength range.

The display panel 11g for green is a third display panel and emits green image light MLg which is third image light. Like the display panel 11r for red, the display panel 11g is, for example, an organic light emitting diode display, forms a still image or a movie on a two-dimensional display surface parallel to the XY plane, and emits the green image light MLg. The light emitting element 14a incorporated in the display panel 11g for green and the light emitting element 14a of the display panels 11r and 11b for red and blue are different from each other in light emitting wavelength. Thus, the red image light MLr which is the first image light and the blue image light MLb which is the second image light are different from each other in wavelength range. Thus, the green image light MLg which is the third image light, the red image light MLr which is the first image light, and the blue image light MLb which is the second image light are different from each other in wavelength range.

Each of the light emitting elements 14a incorporated in the display panels 11r, 11b, and 11g is an organic light emitting diode display provided with a first order resonance type cavity. Therefore, according to the orientation characteristics of the display panels 11r, 11b, and 11g, the light intensity is high in the front side direction parallel to the optical axis AX, and the light intensity sharply drops in a direction slightly inclined with respect to the front side direction. Assuming that an angle at which the light intensity is halved is a radiation angle, the radiation angle from the pixel for the red image light MLr, the radiation angle from the pixel for the blue image light MLb, and the radiation angle from the pixel for the green image light MLg from the pixel are within about 20°. Dichroic mirrors 18r and 18b of the cross dichroic prism 18, which will be described later, are designed based on the radiation angles of the image light MLr, MLb, and MLg.

In an organic light emitting diode device or an organic EL device, the first order resonance type cavity provided to the light emitting element 14a is formed by a reflective electrode disposed below the light emitting layer and a transmissive and reflective counter electrode disposed above the light emitting layer (for a specific structure of the cavity, see, for example, JP-A-2016-170936). Note that the cavity is characterized by the following resonance formula

2D−Φ=mλ(m=0,1,2,3, . . . ), wherein
D is an optical distance from the reflection electrode to the counter electrode (half mirror)

$$( = Σ \qquad ( refractive index \times film thickness ) )$$

Φ is a total phase shift
(=phase shift φU at counter electrode+phase shift φL at reflective electrode), and
m is resonance order. That is, in the case of a first order resonance type cavity, m=1 holds.

The organic light emitting diode display is not limited to one provided with the first order resonance type cavity, but may be one provided with a zeroth order resonance type cavity meaning that m=0 holds, or may be one provided with a second or higher order resonance type cavity meaning that m=2, . . . holds. In general, compared with the zeroth order resonance type cavity, the first order resonance type cavity features high luminance, but involves a relatively high peak in the light distribution characteristic resulting in low beam uniformity.

The display panel 11r for red is fixed so as to be attached to a first light incident surface 18ib of the cross dichroic prism 18. The first display panel 11r for red causes the red image light MLr, which is the first image light, to enter the cross dichroic prism 18 from the first light incident surface 18ib. The display panel 11b for blue is fixed so as to be attached to a second light incident surface 18ic of the cross dichroic prism 18. The second display panel 11b for blue causes the blue image light MLb, which is the second image light, to enter the cross dichroic prism 18 from the second light incident surface 18ic. The display panel 11g for green is fixed so as to be attached to a third light incident surface 18ia of the cross dichroic prism 18. The third display panel 11g for green causes the green image light MLg, which is the third image light, to enter the cross dichroic prism 18 from the third light incident surface 18ia.

The cross dichroic prism 18 has a structure in which four right-angled triangular prisms formed of a glass material or the like are joined with the right-angled edges coinciding with each other, and two dichroic mirrors 18r and 18b orthogonal to each other are embedded in the joint portions. One dichroic mirror 18r is disposed at an angle of 45° with respect to the first incident surface 18ib. The dichroic mirror 18r forms a surface connecting diagonal corners of a square contour as viewed in the direction of an intersecting axis CX of the cross dichroic prism 18. The other dichroic mirror 18b is disposed at an angle of 45° with respect to the second incident surface 18ic. The dichroic mirror 18b forms a surface connecting diagonal corners of a square contour as viewed in the direction of an intersecting axis CX of the cross dichroic prism 18.

The red image light MLr having entered the first incident surface 18ib of the cross dichroic prism 18 from the first display panel 11r for red is reflected by the dichroic mirror 18r to be bent toward the emission side, that is, the projecting optical system 20, and is emitted from a light emission surface 18o to the outside in the +Z direction. The blue image light MLb having entered the second incident surface 18ic of the cross dichroic prism 18 from the second display panel 11b for blue is reflected by the dichroic mirror 18b to be bent toward the emission side, that is, the projecting optical system 20, and is emitted from the light emission surface 18o to the outside in the +X direction. The green image light MLg having entered the third incident surface 18ia of the cross dichroic prism 18 from the third display panel 11g for green passes through the cross dichroic prism 18 toward the projecting optical system 20 without being reflected by the dichroic mirrors 18r and 18b, and is emitted from the light emission surface 18o to the outside in the +Z direction. That is, the green image light MLg transmits through the cross dichroic prism 18. As a result, the images can be combined with the red image light MLr, the green image light MLg, and the blue image light MLb superimposed in the cross dichroic prism 18, to be emitted as the image light ML and caused to enter the projecting optical system 20.

In the cross dichroic prism 18, the intersecting axis CX extends along the line of intersection of the two dichroic mirrors 18r and 18b and is parallel to the Y direction. The optical axis AX passing through the light emission surface 18o of the cross dichroic prism 18 extends in a lateral direction perpendicular to the light guide plate 51a, that is, in the Z direction.

The projecting optical system 20 is an optical system that is substantially telecentric with respect to the side of the display panels 11r, 11b, and 11g, which is the object side. That is, the principal light beam of the image light MLg, the image light MLr, and the image light MLb emitted from the respective portions of the light emitting elements 14a which are the display surfaces of the respective display panels 11b, 11r, and 11g pass through the light incident surfaces 18ib, 18ic, and 18ia of the cross dichroic prism 18 in a state of being substantially parallel to the optical axis AX, and thus enters the cross dichroic prism 18 and is emitted from the cross dichroic prism 18 while being substantially parallel to the optical axis AX. Accordingly, the red image light MLr, the green image light MLg, and the blue image light MLb within a predetermined angle range or less enter the dichroic mirrors 18r and 18b, whereby the light loss due to the dichroic mirrors 18r and 18b can be suppressed.

In this case, the incident diffractive layer 51b which is the input diffractive optical element DI is of a slanted type, a binary type, or a blazed type diffraction element, and has a diffraction efficiency distribution exhibiting a tendency to cancel the unevenness NU of the image light ML entering the input diffractive optical element DI.

### Others

The structures described above are examples and various modifications can be made without departing from the scope capable of achieving the same functions.

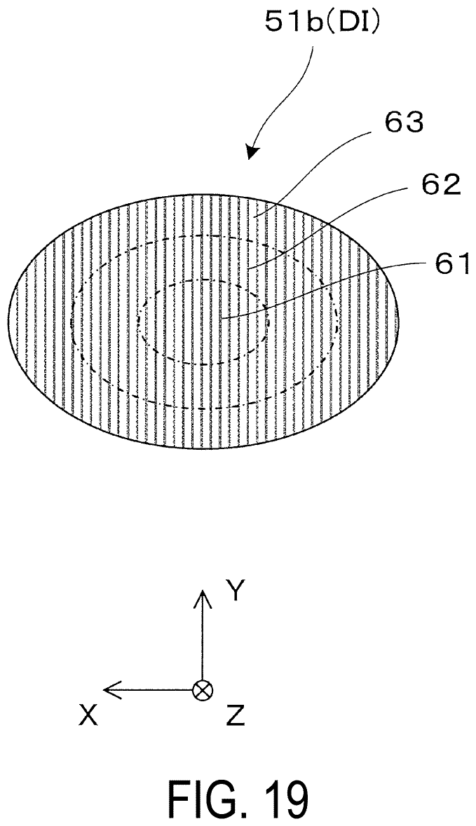

As illustrated in FIG. 19, the shape of the incident diffractive layer 51b or the input diffractive optical element DI is not limited to a circular shape but may be an elliptical shape. When the light distribution characteristic of the display panel 11a is biased in the lateral X direction and the luminance is high, the zones 61, 62, and 63 provided in the input diffractive optical element DI may also be elliptical. Also in this case, the diffraction efficiency distribution in the input diffractive optical element DI exhibits a tendency to cancel the unevenness NU of the image light ML entering the input diffractive optical element DI in accordance with the light distribution characteristics of the display panel 11a.

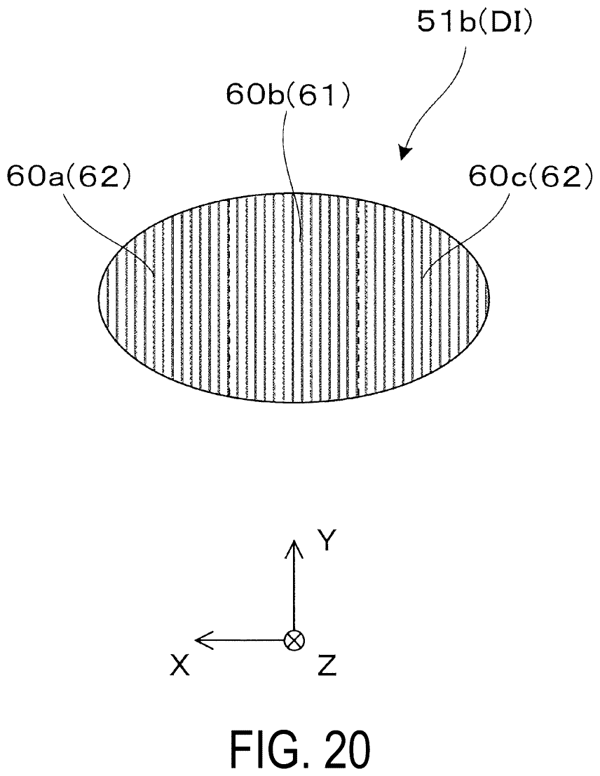

When the aspect ratio of the display panel 11a illustrated in FIG. 5 indicates a longer length in the horizontal X direction than in the vertical Y direction, the incident diffractive layer 51b or the input diffractive optical element DI may include the block areas 60a, 60b, and 60c sectionalized only in the horizontal X direction as illustrated in FIG. 20. In this case, DE1<DE2 holds where DE1 is the diffraction efficiency of the first zone 61 including the block area 60b and DE2 is the diffraction efficiency of the second zone 62 including the block areas 60a and 60c and the like. In this case, on the assumption that the unevenness of the image light ML is large in the lateral direction and small in the vertical direction, the diffraction efficiency is adjusted only in the lateral direction.

The light guide member 50 is not limited to one including the incident diffractive layer 51b, the emission diffractive layer 51c, and the pupil expanding grating layer 51e, and for example, the pupil expanding grating layer 51e can be omitted. In this case, the incident diffractive layer 51b causes the collimated image light ML to be guided into the light guide plate 51a and propagate in the lateral direction, and the emission diffractive layer 51c causes the image light ML to be emitted toward the pupil position PP on the inner side of the image light ML propagating in the lateral direction in the light guide plate 51a.

In the light guide member 50, the incident diffractive layer 51b, the emission diffractive layer 51c, and the pupil expanding grating layer 51e may be disposed on the second total reflection surface 51 on the external side, that is, the +Z side of the light guide plate 51a. In this case, the incident diffractive layer 51b, the emission diffractive layer 51c, and the pupil expanding grating layer 51e are designed to function as reflective diffraction elements that partially transmit external light.

The incident diffractive layer 51b, the emission diffractive layer 51c, and the pupil expanding grating layer 51e may be formed from volumetric holograms. In this case, the diffraction efficiency distribution of the incident diffractive layer 51b is obtained by adjusting the modulation degree of the refractive index difference. The incident diffractive layer 51b, the emission diffractive layer 51c, and the pupil expanding grating layer 51e are not limited to ones formed of a single layer, and may be formed by stacking a plurality of functional layers adapted to the wavelengths and the angle of view direction of the image light ML.

The emission diffractive layer 51c and the pupil expanding grating layer 51e may have a spatial diffraction efficiency distribution so as to reduce macroscopic display unevenness or image unevenness.

The light guide member 50 may be formed by stacking a plurality of light guides in parallel. In this case, the light guides as the components may respectively correspond to three colors of RBG, for example. Each light guide includes the light guide plate 51a, the incident diffractive layer 51b, the emission diffractive layer 51c, and the pupil expanding grating layer 51e.

Although it has been described above that the virtual image display device 100A, 100B can be used as an HMD, the present disclosure is not limited thereto and can be applied to various optical devices, for example, a head-up display (HUD).

A virtual image display device according to a specific aspect includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element has a diffraction efficiency distribution having a tendency to cancel unevenness of the image light entering the input diffractive optical element.

In the virtual image display device, since the input diffractive optical device has the diffraction efficiency distribution having a tendency to cancel the unevenness of the image light entering the input diffractive optical element, even if the unevenness of the image light is formed on the input diffractive optical device due to the light distribution characteristics of the display panel, the image light can be guided into the light guide plate with the distribution thereof restricted. Thus, the display unevenness such as pixel luminance variation due to a movement of the line of sight.

In the virtual image display device according to a specific aspect, a design parameter of the input diffractive optical element uniformizes a beam profile of the image light entering the input diffractive optical element from the projection optical system. In this case, the luminance distribution of the image light entering the input diffractive optical element is uniformized.

In the virtual image display device according to a specific aspect, the input diffractive optical element is one of a slanted type, a binary type, and a blazed type.

In the virtual image display device according to a specific aspect, in the input diffractive optical element, an inclination angle, a depth, and a duty ratio of a diffractive structure are changed in accordance with the beam profile of the image light.

In the virtual image display device according to a specific aspect, diffraction efficiency of the input diffractive optical element is relatively higher in periphery than at center. For the case where the light distribution characteristic of the display panel is strong in the direction of the principal light beam and becomes weak as the angle with respect to the principal ray increases, the diffraction efficiency of the input diffractive optical element cancels such an orientation characteristic, thereby suppressing display unevenness.

In the virtual image display device according to a specific aspect, the input diffractive optical element has a concentric and symmetrical diffraction efficiency distribution. In this case, it is possible to suppress the display unevenness in the upper-lower and left-right directions.

In the virtual image display device according to a specific aspect, diffraction efficiency of the input diffractive optical element changes with respect to a direction achieving a higher aspect of the display panel. In this case, it is possible to suppress the display unevenness in a direction with a larger impact.

In the virtual image display device according to a specific aspect, the display panel is an organic light emitting diode display provided with a first order resonance type cavity.

In the virtual image display device according to a specific aspect, the light guide member includes an expanding diffractive optical element configured to expand a pupil of the output diffractive optical element while guiding the image light guided into the light guide plate from the input diffractive optical element to the output diffractive optical element.

The virtual image display device according to a specific aspect includes as the display panel, a first display panel configured to first image light corresponding to image light, a second display panel configured to emit second image light of a wavelength range different from that of the first image light, a third display panel configured to emit third image light of a wavelength range different from those of the first image light and the second image light, and a cross dichroic prism configured to combine the first image light, the second image light, and the third image light. With the first display panel, the second display panel, and the third display panel thus combined, it is possible to display a virtual image with high luminance.

An optical unit according to a specific aspect includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element has a diffraction efficiency distribution having a tendency to cancel unevenness of the image light entering the input diffractive optical element.

What is claimed is:

1. A virtual image display device comprising:
a display panel configured to emit image light;
a projection optical system configured to collimate the image light from the display panel; and
a light guide member that includes a light guide plate configured to guide the image light, an input diffractive optical element configured to cause the image light to enter the light guide plate, and an output diffractive optical element configured to cause the image light to be emitted from the light guide plate, wherein
the input diffractive optical element has a diffraction efficiency distribution having a tendency to cancel unevenness of the image light entering the input diffractive optical element.

2. The virtual image display device according to claim 1, wherein a design parameter of the input diffractive optical element uniformizes a beam profile of the image light entering the input diffractive optical element from the projection optical system.

3. The virtual image display device according to claim 1, wherein the input diffractive optical element is one of a slanted type, a binary type, and a blazed type.

4. The virtual image display device according to claim 3, wherein in the input diffractive optical element, an inclination angle, a depth, and a duty ratio of a diffractive structure are changed in accordance with the beam profile of the image light.

5. The virtual image display device according to claim 1, wherein diffraction efficiency of the input diffractive optical element is relatively higher in periphery than at center.

6. The virtual image display device according to claim 5, wherein the input diffractive optical element has a concentric and symmetrical diffraction efficiency distribution.

7. The virtual image display device according to claim 1, wherein diffraction efficiency of the input diffractive optical element changes with respect to a direction achieving a higher aspect of the display panel.

8. The virtual image display device according to claim 1, wherein the display panel is an organic light emitting diode display provided with a first order resonance type cavity.

9. The virtual image display device according to claim 1, wherein the light guide member includes an expanding diffractive optical element configured to expand a pupil of the output diffractive optical element while guiding the image light guided into the light guide plate from the input diffractive optical element to the output diffractive optical element.

10. The virtual image display device according to claim 1, comprising:
as the display panel, a first display panel configured to emit first image light corresponding to the image light;
a second display panel configured to emit second image light of a wavelength range different from that of the first image light;
a third display panel configured to emit third image light of a wavelength range different from those of the first image light and the second image light; and
a cross dichroic prism configured to combine the first image light, the second image light, and the third image light.

11. An optical unit comprising:
a display panel configured to emit image light;
a projection optical system configured to collimate the image light from the display panel; and
a light guide member that includes a light guide plate configured to guide the image light, an input diffractive optical element configured to cause the image light to enter the light guide plate, and an output diffractive optical element configured to cause the image light to be emitted from the light guide plate, wherein
the input diffractive optical element has a diffraction efficiency distribution having a tendency to cancel unevenness of the image light entering the input diffractive optical element.
